(19) United States
(12) Patent Application Publication
(10) Pub. No.: US 2016/0176085 A1
(43) Pub. Date: Jun. 23, 2016

(54) METHOD AND SYSTEM FOR PRODUCING COMPOSITE STRUCTURES

(71) Applicant: Airbus Operations GmbH, Hamburg (DE)

(72) Inventors: Wouter Brok, Politz (DE); Bernd SCHWING, Hamburg (DE); Pierre C. Zahlen, Stade (DE)

(21) Appl. No.: 14/577,598

(22) Filed: Dec. 19, 2014

(51) Int. Cl. B29C 45/14; B64C 1/06; B64F 5/00; B29C 45/00

(52) U.S. Cl. CPC B29C 45/14; B29C 45/0005; B64C 1/061; B64F 5/0009; B29K 2101/12

(57) ABSTRACT

The subject matter disclosed herein relates to a method of producing a composite structure, such as an airframe or fuselage of an aircraft. The method comprises the steps of: arranging a first component within a cavity of a mold; arranging a second component adjacent the cavity of the mold containing the first component and sealing the cavity against the second component; injecting a polymer or resin into the cavity of the mold to infuse and/or pervade gaps or spaces between the first component and the second component; and curing or setting the polymer or resin within the mold to bond the first component with the second component and so form the composite structure. The subject matter disclosed herein also provides a system for carrying out the above method.

### TECHNICAL FIELD

The subject matter disclosed herein relates to a method and a system for producing a composite structure, and especially for use in fabricating a vehicle body structure formed from one or more composite components, such as fiber-reinforced polymer (FRP) components. The subject matter disclosed herein also relates to a vehicle structure, particularly a fuselage or airframe structure for an aircraft or spacecraft, fabricated using such a method and/or system.

### BACKGROUND

Airframe and fuselage structures produced today are typically weight-optimized and therefore designed for relatively high loading. Such structures generally demand small assembly- and mating-tolerances compared to their overall dimensions; for example, assembly/mating tolerances of tenths of a millimeter for components of several meters in size. Some techniques for addressing this challenge in fuselage or airframe structures fabricated from composite components include: (1) pairing two soft (i.e. non-cured) components for so-called “co-curing”; (2) pairing a soft (non-cured) component with a hard (cured) component for so-called “co-bonding”; (3) pairing two hard (cured) components and closing gaps between them using solid elements by so-called “shimming”; and (4) forming the mating surfaces of two hard (cured) components by milling them to create neat- or well-fitting surfaces; i.e. milling so-called sacrificial layers.

The techniques (1) and (2) pose the challenge of handling the relatively soft (non-cured) prepregs or fiber preforms. When at least one component is soft, the topology of the mating surfaces and the positioning accuracy will dictate the post-process shape of the soft component(s). These techniques (1) and (2) can thus help to avoid gaps. Currently, typical cycle times for these kinds of processes are several hours or days. Furthermore, these solutions (1) and (2) are often used on the critical path of component manufacturing. They are not typically applied in major component assembly (MCA) or final assembly line (FAL) procedures.

Technique (3) is typically very time-consuming. Today it is a multi-step process, in which each process step takes several hours. Unlike solutions (1) and (2), the shimming process is usually applied in the MCA and FAL procedures. Hence, it is in a critical path of the overall aircraft production cycle and thus has a major impact on lead-time, recurring costs and also the required investment (e.g. if parallel stations are required due to the long process lead-time).

Technique (4) requires additional thickness on the assembly components (sacrificial layers) that can be milled or sanded away to achieve the required mating surface quality. This approach is normally not weight-optimized and is challenging with respect to tolerance management (i.e. milling accuracy, and positioning tolerances in the milling device and during the mating of assembly partners).

### SUMMARY

It is therefore an aspect of the subject matter disclosed herein to provide a new and improved technique for producing or fabricating a composite structure, especially a structure having a complex geometry, which overcomes one or more of the problems and disadvantages of known techniques, including excessively long production times, material wastage, dimensional inaccuracy and/or inadequate structural quality.

In accordance with this subject matter disclosed herein, a method and a system are provided for producing a composite structure, and especially for fabricating of a vehicle body structure from fiber-reinforced polymer components. Also, in accordance with this subject matter disclosed herein, a vehicle body structure, and especially a fuselage structure for an aircraft or spacecraft, are provided. Preferred features of the subject matter disclosed herein are recited in the dependent claims.

According to one aspect, therefore, the subject matter disclosed herein provides a method of producing a composite structure, such as a fuselage or airframe structure of an aircraft, comprising the steps:
arranging a first component in a cavity of a mold;
arranging a second component adjacent the cavity of the mold containing the first component and sealing the cavity against the second component;
injecting a polymer or resin material into the cavity of the mold to infuse and/or pervade gaps or spaces between the first component and the second component; and
curing or setting the polymer or resin material within the mold to bond the first component to the second component in the structure.

With the method of the subject matter disclosed herein, it is possible to combine the two components and to compensate for different tolerances by injecting the polymer or resin material into and/or around any gaps or spaces between those components. Thus, the filling of any gaps or spaces and the compensation of tolerances occurs in a single and fast injection molding operation, and no time-consuming shimming is required. The polymer or resin material is typically injected in liquid form thus enabling it to readily and quickly spread and fill any gaps or spaces between the two components. The cavity of the mold typically defines an outer geometry for at least a part of the structure to be produced, and the first component may be received in the mold to abut or to contact the second component when the cavity of the mold is sealed against the second component.

In a preferred embodiment of the subject matter disclosed herein, at least one of the first and second components, and preferably both, is a composite component. That is, either or both of the first and second components may comprise or be formed from a composite material, such as a fiber-reinforced polymer (FRP). In this regard, in a particularly preferred embodiment, at least the first component arranged in the cavity of a mold is provided as a composite component. The second component, on the other hand, may be of any suitable material for the structure to be produced. For example, the second component may be formed of a plastic or polymer material, aluminum, titanium, steel, or some other metal, or a ceramic. For a broad conceptualization of this subject matter disclosed herein, it will be noted that the first component could also be formed from one of the non-composite materials listed, such that neither of the first or second components is itself comprised of a composite material. In the preferred embodiments described hereafter, however, at least the first component and preferably both the first and second components will be presumed to be composite components.

In one preferred embodiment of the subject matter disclosed herein, the polymer or resin material is a thermosetting polymer or synthetic resin and is desirably compatible with a polymer of the first and/or second composite component for co-curing or co-bonding with those components. In this regard, examples include epoxy resins, polyester resins, vinyl ester resins, and phenol formaldehyde resins.

In another preferred embodiment of the subject matter disclosed herein, the polymer or resin material is a thermoplastic polymer or resin, which may set upon cooling after injection into the mold. By employing the method of the subject matter disclosed herein with a thermoplastic polymer or resin, the assembly of the first and second components can proceed with very quick process times, because setting of the polymer or resin occurs readily or directly (e.g. within minutes) upon cooling such that the components are then fixed or bonded to each other. Desirably, the polymer or resin material may include one or more filler or reinforcing additive, such as short fibers. In this way, the structural characteristics of the thermoplastic polymer or resin material injected can be adjusted and/or enhanced to provide desired properties (e.g. strength) in a joint between the first and second components upon setting of the polymer or resin material.

At this stage, the method may include one or more additional fixation step in which the joint between the first and second components is reinforced with mechanical fastening elements, such as rivets. In particular, after curing or setting the polymer or resin material within the mold to bond the first and second components into the desired structure, the method may include removing the structure from the mold and fixing and/or reinforcing the joint between the first and second components by mechanical fastening elements, such as rivets. Mechanical fastening techniques like riveting are well known in the field and so will not be described here in detail.

In a particularly preferred embodiment of the subject matter disclosed herein, the first component is a composite “prepreg” or non-cured, fiber-reinforced polymer preform and the second component may be a cured, fiber-reinforced polymer (FRP) component. The fibers employed in these composite components are typically selected from the group consisting of glass, aramid and carbon fibers, though carbon fiber-reinforced polymer (CFRP) materials are especially preferred. It will be noted, however, that other composite materials may also be employed. Where the first component is a prepreg or non-cured preform, the polymer or resin material selected for injection into the mold may be a thermosetting polymer or resin compatible with the polymer of the prepreg for co-curing therewith after the injecting step is complete. In this regard, the step of curing or setting the injected polymer or resin material in the mold to bond the first and second composite components in the composite structure may include heating the mold to effect co-curing of the thermosetting polymer or resin and the prepreg.

In a preferred embodiment, the step of arranging the second component adjacent the cavity of the mold includes one or more of: pressing the second component against an open side of the mold; and pressing an open side of the mold against the second component. In this connection, pressing the second component against an open side of the mold preferably involves providing a support member that both supports, and applies pressure to, the second component to press it towards and against the mold. The support member typically includes a resilient or flexible contact surface for contact with a corresponding bearing surface of the second component. Also, a seal member is preferably provided around the cavity of the mold for sealing against the second component. In this way, the seal member prevents unwanted leakage of the polymer or resin material from the mold cavity during the injecting step.

In a particularly preferred embodiment of the subject matter disclosed herein, it is possible to automate the method to provide fast, accurate, and repeatable industrial structure production and assembly in a single operation. In this regard, the method may employ one or more robot arm for positioning the mold and/or the second component relative to the mold via a support member for counter pressure.

As will be appreciated, the method of the subject matter disclosed herein may be employed for producing various composite structures in the airframe or fuselage of an aircraft. For example, the method is particularly suitable for the production of complex panel areas or parts of an airframe or fuselage structure, such as a window frame and skin assembly, clip to skin/frame assembly, frame to skin assembly and/or DSS to skin assembly. Indeed, skilled persons will understand that the method and technique of the subject matter disclosed herein can essentially be applied or transferred to other resin/fiber systems and applications.

According to another aspect, the subject matter disclosed herein provides a system for producing a composite structure, particularly an airframe or fuselage structure of an aircraft, comprising:
a mold having a cavity for receiving a first component;
a support member for supporting and/or applying pressure to a second component adjacent the mold, whereby the cavity of the mold having the first component is sealed against the second component;
injector means for injecting a polymer or resin into the cavity of the mold to infuse and/or pervade gaps or spaces between the first component and the second component. Thus, the injected polymer or resin may provide consistent, stable and well-fitting contact between the first and the second components.

As noted above, desirably at least one of the first component and the second component, and preferably both, is comprised of a composite material such as a fiber-reinforced polymer, especially a carbon fiber-reinforced polymer (CFRP) material. In at least one embodiment, however, it is contemplated that the first and/or second component may be comprised of any suitable material for the structure to be produced, including but not limited to a plastic or polymer material, aluminum, titanium, steel, or some other metal, or a ceramic.

In a particularly preferred embodiment of the subject matter disclosed herein, the system may further comprise heater means for heating the polymer or resin material together with the first component in the cavity of the mold and/or the second component to set or cure the polymer or resin material and thereby to bond the first and second components and form the composite structure.

According to a further aspect, the subject matter disclosed herein provides an aircraft having an airframe or fuselage structure produced by a method according to the subject matter disclosed herein as described above in relation to any one of the embodiments.

### BRIEF DESCRIPTION OF THE DRAWINGS

For a more complete understanding of the subject matter disclosed herein and the advantages thereof, exemplary embodiments of the subject matter disclosed herein are explained in more detail in the following description with reference to the accompanying drawings, in which like reference characters designate like parts and in which:

FIG. 1 is a perspective view of part of a hull or fuselage structure of an aircraft, i.e. a window frame panel formed from fiber-reinforced polymer components;

FIG. 2a is a schematic illustration of a method step in the forming of a structure with a method and system according to an embodiment of the subject matter disclosed herein;

FIG. 2b is a schematic illustration of another method step in forming a structure with the method and system according to an embodiment of the subject matter disclosed herein;

FIG. 2c is a schematic illustration of a further method step in forming a structure with the method and system according to an embodiment of the subject matter disclosed herein;

FIG. 2d is a schematic side view of the structure produced with the method and system of the subject matter disclosed herein;

FIG. 3 is a schematic illustration of an aircraft having a fuselage structure fabricated using the method and system of an embodiment of the subject matter disclosed herein;

FIG. 4 is a flow diagram that schematically illustrates a method according to an embodiment of the subject matter disclosed herein.

The accompanying drawings are included to provide a further understanding of the subject matter disclosed herein and are incorporated in and constitute a part of this specification. The drawings illustrate particular embodiments of the subject matter disclosed herein and together with the description serve to explain the principles of the subject matter disclosed herein. Other embodiments of the subject matter disclosed herein and many of the attendant advantages of the subject matter disclosed herein will be readily appreciated as they become better understood with reference to the following detailed description.

### DETAILED DESCRIPTION

It will be appreciated that common and well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not necessarily required. It will also be understood that the terms and expressions used in the present specification have the ordinary meaning as is accorded to such terms and expressions with respect to their corresponding respective areas of inquiry and study, except where specific meanings have otherwise been set forth herein.

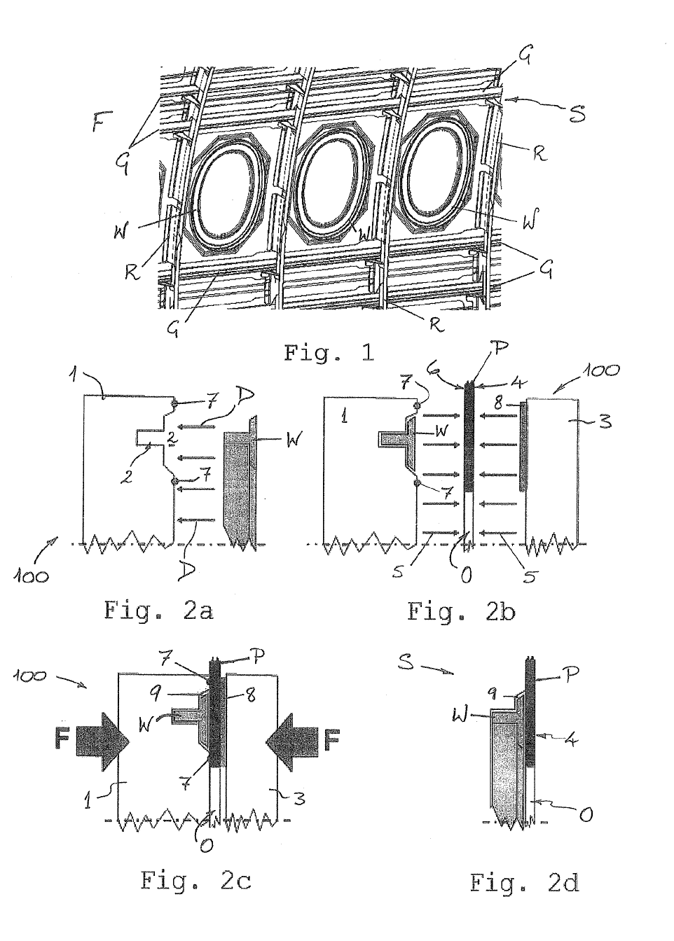

With reference firstly to FIG. 1 of the drawings, a composite structure S forming part of a fuselage or an airframe F of an aircraft is illustrated. In this embodiment, the composite structure S includes a plurality of fiber-reinforced polymer components (e.g. CFRP components) as structural members in the form of ribs R, stringers G, and oval-shaped window frame members W that are interconnected or secured with one another and to an outer panel or skin P via a range of techniques to form a window section S of the fuselage or airframe F shown.

Referring now to FIGS. 2a to 2d of the drawings, a system 100 and a corresponding method will be described for producing a structure S as shown in FIG. 1 according to an embodiment of this subject matter disclosed herein. The system 100 and method of this particular embodiment in FIGS. 2a-2d is specifically shown and described with reference to that part of the structure S involving the interconnection or assembly of an oval-shaped window frame W and an outer panel or skin P of the fuselage structure.

As can be seen in FIG. 2a, the system 100 includes a mold or molding tool 1 which defines a mold cavity 2 for receiving a first composite component, such as the oval-shaped window frame component W. In this regard, it will be noted that the mold or molding tool 1 is shown in cross-section such that the cavity 2 merely represents the cross-sectional profile of the window frame component W. In this embodiment, the window frame component W has a T-shaped cross-sectional profile or geometry that substantially conforms to the cavity 2 in the molding tool 1 enabling the window frame component W to be substantially fully received and accommodated within that mold cavity 2. The window frame component may, for example, be a “prepreg” or a non-cured CFRP preform, or alternatively a cured CFRP component, and the arrows D in FIG. 2a show the direction for inserting that window frame component W into the cavity 2 of the molding tool 1.

Referring now to FIG. 2b of the drawings, the window frame component W can be seen fully received or accommodated in the mold cavity 2, with only a small amount of space or “play” between it and the mold 1. A second composite component, in this case a panel or skin component P having an opening O for the window formed therein, is arranged or positioned adjacent to the mold 1. Furthermore, a support member 3 is provided at a side 4 of the panel component P remote from the mold 1 and both the mold 1 and the support member 3 are configured to be moved together in the direction of arrows 5 such that a side 6 of the panel component P facing the mold 1 presses against the mold 1 to close the open mold cavity 2. In this regard, a seal member 7 preferably in the form of a resilient deformable bead is provided on an open side of the mold 1 around a periphery of the cavity 2 for sealing the cavity 2 against the facing side 6 of the composite panel component P. In addition, the support member 3 includes a resilient pad 8 (e.g. of softer material) for contacting and protecting that side 4 of the panel component P remote from the mold 1 as the mold 1 and support member 3 move together and clamp the window frame and panel components W, P between them.

With reference to FIG. 2c, a force F is applied to both the mold 1 and the support member 3 to securely hold and retain the panel or skin component P in sealing engagement with the seal member 7 surrounding the mold cavity. The components W, P and the molding tool 1 are dimensioned such that a base of the inverted T-shaped profile of the window frame component W is very close to or in contact with the facing side 6 of the panel component P. A liquid polymer or resin material 9 is then injected into the closed mold cavity 2 to permeate and fill any gaps or spaces around or between the window frame component W and the panel or skin component P. In this case, the polymer or resin material 9 entirely surrounds the window frame component W in contact with the panel or skin component P as it infuses into the mold and fills any gaps between the components. The polymer or resin material 9 injected into the mold cavity 2 may include short fibers as a strengthening or reinforcing filler.

In one preferred embodiment, particularly where both of the first and second components W, P are pre-cured FRP composite components, the polymer or resin material 9 injected into the mold cavity 2 is a thermoplastic polymer which is heated to a liquid state for easy injection and dispersion through the gaps and spaces within the cavity. In another preferred embodiment, however, particularly where the first component W is a non-cured or only partially-cured “prepreg”, the polymer or resin material injected may be a thermosetting polymer for co-curing and/or co-bonding with the window frame component W and also bonding same to the panel or skin component P, which itself may be of a composite or non-composite material.

Regardless of whether it is a thermoplastic or thermosetting polymer, the injected polymer or resin material 9 is cured or set within the molding tool 1 to bond the window frame component W to the panel or skin component P. In this way, a well-fitting, stable and uniform interface is formed between the two components W, P and the two components are also fixed in the desired spatial relationship to one another within the structure S. FIG. 2d of the drawings shows the structure S comprising the two composite components W, P after removal from the mold 1. The injected resin material 9 surrounds the fiber-reinforced window frame component W after consolidation or setting; i.e. the resin material 9 has filled all of the gaps between the two components W, P and between the mold 1 and the component W.

In a further adaptation or embodiment of this subject matter disclosed herein , the same molding system and process may be used to manufacture complex geometries or shapes attached to either or both of the composite components W, P in the same molding operation; e.g. with appropriate configuration of the mold cavity 2. To this end, the polymer or resin material 9 to be injected may include short fiber reinforcement for strengthening the newly molded geometry.

Additional reinforcing of the joint or interface between the two components W, P may be subsequently provided as required. For example, the window frame component W may subsequently also be riveted to the panel component P of the airframe or fuselage structure F by securing or fastening rivets (not shown) through a flange-type footing or base of the inverted T-shaped profile of the window frame component W and through the panel component P.

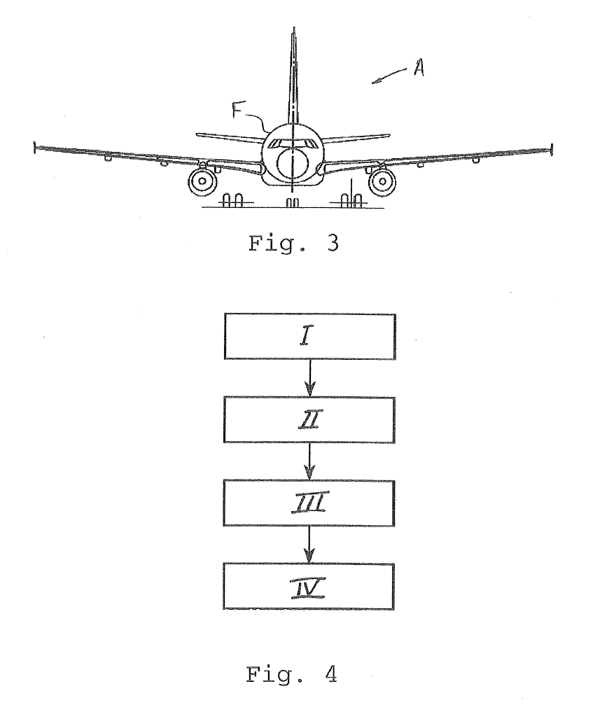

With reference to FIG. 3 of the drawings, an aircraft A is illustrated schematically and can be seen to have a fuselage or airframe F which comprises a composite structure S that substantially corresponds to the window frame section S shown in FIG. 1 of the drawings.

Referring to drawing FIG. 4, a flow diagram schematically illustrates various steps in a preferred method of the subject matter disclosed herein. In particular, the first box I in

FIG. 4 represents the step of arranging a first component, such as the window frame component W, in the cavity 2 of the mold 1, with the cavity 2 of the mold 1 defining an outer geometry for at least part of the composite structure S to be produced or fabricated. The second box II of FIG. 4 represents the step of arranging a second component, such as the panel or skin component P, adjacent to the cavity 2 of the mold 1 containing the first composite component W and sealing that cavity 2 against the second component P. The third box III of FIG. 4 represents the step of injecting a thermoplastic or thermosetting polymer or resin 9 into the cavity to surround, infuse and/or pervade the first component W in contact with the second component P as shown in FIG. 2c. The fourth box IV of FIG. 4 then represents the step of curing or setting the polymer or resin 9 within the mold 1 to bond the first component W with the second component P to thereby form the desired composite structure S.

By employing injection molding techniques to integrate the composite components in the manufacturing of CFRP structures, tolerance compensation and component mating or assembly are able to be accurately achieved in a single industrial process with a high degree of reproducibility and a high production-rate capability.

Although specific embodiments of the subject matter disclosed herein have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

In this document, the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

### LIST OF REFERENCE SIGNS

1 molding tool or mold
2 mold cavity
3 support member
4 side of panel component remote from mold
5 arrows for movement of mold and support member
6 side of panel component facing mold
7 seal member or resilient bead
8 resilient pad or contact surface of support member
9 polymer or resin material
100 system
S composite structure
F fuselage or airframe
R rib
G stringer
W window frame component
P panel or skin component
D insertion direction for first component
O opening in the panel component
A aircraft

What is claimed is:

1. A method of producing a composite structure, such as an airframe or fuselage structure of an aircraft, comprising:
arranging a first component within a cavity of a mold;
arranging a second component adjacent or next to the cavity of the mold containing the first component and sealing the cavity against the second component;
injecting a polymer or resin into the cavity of the mold to infuse and/or pervade gaps or spaces between the first component and the second component; and
curing or setting the polymer or resin within the mold to bond the first component with the second component and thereby form the structure.

2. A method according to claim 1, wherein the polymer or resin is injected into the cavity to surround, infuse and/or pervade the first component in contact with the second component.

3. A method according to claim 1, wherein the first component is a non-cured, fiber-reinforced polymer preform.

4. A method according to claim 1, wherein the second component is a pre-cured, fiber-reinforced polymer component.

5. A method according to claim 1, wherein the second component is a non-composite component comprised of any one of a plastic or polymer material, aluminum, titanium, steel, or other metal, or ceramic.

6. A method according to claim 1, wherein the step of arranging the second component adjacent the cavity of the mold includes one or more of: pressing the second component against an open side of the mold, and/or pressing an open side of the cavity against a facing side of the second component.

7. A method according to claim 6, wherein the step of pressing the second component against an open side of the cavity includes providing a support member which supports and applies pressure to the second component thereby to press it towards and against the mold.

8. A method according to claim 7, wherein the support member comprises a resilient or flexible contact pad or surface for contact with a bearing surface of the second component.

9. A method according to claim 1, wherein a seal member is provided around the cavity of the mold for sealing against the second component.

10. A method according to claim 1, wherein the polymer or resin material is a thermosetting polymer or synthetic resin and is preferably compatible with a polymer of the first and/or second component for co-curing or co-bonding therewith.

11. A method according to claim 1, wherein the polymer or resin material is a thermoplastic polymer or resin, which may set upon cooling after injection into the mold.

12. A method according to claim 1, wherein the polymer or resin material includes a filler, such as short fibers, for a reinforcing or strengthening effect.

13. A system for producing a composite structure, such as in a fuselage or airframe of an aircraft, comprising:
a mold having a cavity for receiving a first component;
a support member for supporting and/or applying pressure to a second component adjacent the mold such that the cavity of the mold containing the first component is sealed against the second component;
injector means for injecting a polymer or resin into the cavity of the mold to pervade and fill gaps and/or spaces between the first component and the second component.

14. A system according to claim 13, further comprising heater means for heating the polymer or resin together with the first component and/or the second component in the cavity of the mold, e.g. to cure the polymer or resin and bond the first and second components to form the structure.

15. An aircraft having an airframe or fuselage structure produced by a method according to claim 1.
